(19) United States
(12) Patent Application Publication
(10) Pub. No.: US 2009/0194038 A1
(43) Pub. Date: Aug. 6, 2009

(54) Safety Bangle with Banglets

(76) Inventor: Leslie Blair Burgett, Merritt Island, FL (US)

Correspondence Address: LESLIE BLAIR BURGETT, 600 HIGHPOINT COURT, MERRITT ISLAND, FL, 32952, US

(21) Appl. No.: 12/012,473

(22) Filed: Feb. 4, 2008

(51) Int. Cl. A62B 35/00

(52) U.S. Cl. 119/770

(57) ABSTRACT

This Safety Bangle is devised to prevent children, guided individual or guardian from being separated from each other by the utility of a multi-featured (rotating) lobster claw hook and rubber coiled tether attached to buckled, Safety Bangles. The device keeps the child or guided individual close when required and also allows freedom of movement. The rotating hooks allow for flexibility in movement while in use and the hooks maybe attached to other locations (e.g. belt loops). The hooks also allow the coil to be taken off without removing the Safety Bangles. This will allow time apart, such as eating dinner at a restaurant, while offering immediate and easy connectivity when needed. The buckled Safety Bangle is used to fit around the wrist or waist without the worry of elastic slipping over the hand or Velcro coming undone allowing the two to become separated. The buckled Safety Bangle has the ability to be adorned with “Banglets” so the child or guided individual will be more receptive to wearing a more entertaining device while getting the freedom to move about with minimal restraint.

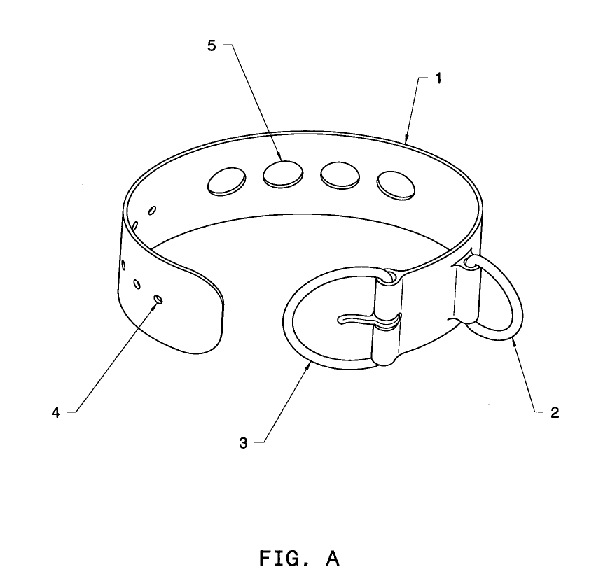

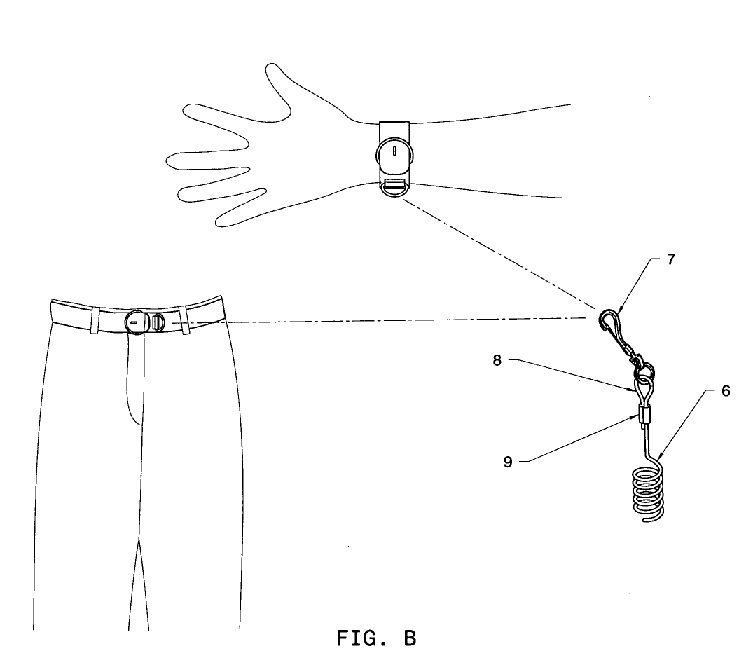

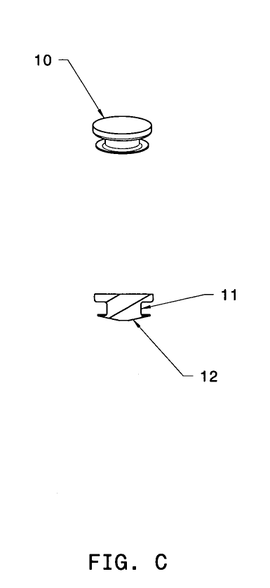

With child abduction on the rise, especially in stores or crowded environments, it can be extremely difficult to keep an eye on a single individual let alone multiple individuals. Because this device is easy to wear and poses minimal interference of normal activities, it provides a security and safety of knowing where the child or guided individual is at all times without fear of losing that individual.

### CROSS-REFERENCE TO RELATED APPLICATIONS

| | | |
|---|---|---|
| 2994300 | July 1958 | Grahling |
| 4414969 | November 1983 | Heyman |
| 4422455 | December 1983 | Olsen |
| 4521922 | June 1985 | Mitchell |
| 4667624 | May 1987 | Smith |
| 4688564 | August 1987 | Kelly |
| 4729345 | March 1988 | Anderson |
| 4745883 | May 1988 | Baggetta |
| 4751896 | June 1988 | Miley |
| 4765279 | August 1988 | Klickstein |
| D310716 | September 1990 | Trask |
| 5275178 | January 1994 | Roberson et al. |

### FEDERALLY SPONSORED RESEARCH OR DEVELOPMENT

Not Applicable

### REFERENCE TO SEQUENCE LISTING, A TABLE, OR A COMMPUTER PROGRAM LISTING COMPACT DISC APPENDIX

Not Applicable

### BACK GROUND OF THE INVENTION

There are two Safety Bangles (bracelet/belt-like) that are connected by rotating lobster claw hooks attached to a rubber coiled tether (one for guardian and the other for child or guided individual). The Safety Bangle may also be fabricated longer in length to interchange as a Belt which may be substituted for the Safety Bangle if desired. This would be placed around the waist instead of the wrist. The Safety Bangles/Belts allow for adjustment in size of wrist/waist and are made of a soft pliable rubber for comfort. The hook may be removed from the Safety Bangle to hook to belt loops. The buckle featured on the Safety Bangle keeps it from slipping over the hand (as would elastic) or be pulled apart (as would Velcro). The rubber coiled tether will stretch to approximately 36 inches but in a static state remains approximately 18 inches. The benefit of this is that it does not afford the coil the opportunity to get wrapped around other items/people while in a flaccid state or in crowded areas. The Safety Bangle itself will have small holes for Banglets (charms) to be inserted to offer an aesthetic appearance for the child or guided individual and make it more entertaining for them to wear. The utility of the Safety Bangle to be put on/off comfortably and easily makes it easy to promote a safe environment in crowded areas for a young child or person needing guidance assistance (not intended for guiding blind individuals) while making it fun and decorative to wear. Banglets are not safe for children under the age of three.

### BRIEF DESCRIPTION OF THE SEVERAL VIEWS OF THE DRAWING

FIG. A: Actual Design of Safety Bangle.

FIG. B: Safety Bangle and Coiled Tether Design with Application.

FIG. C: Banglet Construction

### DETAILED DESCRIPTION OF THE INVENTION

FIG. A: Actual Design of Safety Bangle. (All sizes are approximations.)
1. The Safety Bangle is about 1½-2 inches wide and approximately ⅛ inch thick and is made of a similar rubber substance as the coil, but is made to lay flat against the wrist or waist (like a belt), so the length may vary.
2. Attached to the Safety Bangle is a D-ring to hook the coiled tether to the Safety Bangle by the lobster claw hook.
3. Each Safety Bangle has a buckle on one end.
4. Each Safety Bangle has multiple small holes on the other to accommodate size of wrist or waist.
5. The Safety Bangle also has larger holes along the back side to accommodate “Banglets” (charms) that are used for aesthetic purposes for the child and make the Safety Bangle fun to wear with least resistance.

FIG. B: Safety Bangle and Coiled Tether Design with Application.
6. A ¾ inch rubber/flexible material coiled tether with a diameter of each coil-ringlet at approximately 2-3 inches. Coil material will not only be flexible, but maintain integrity and hardiness to resistance of tugging and pulling.
7. The lobster claw hooks have the ability to rotate to give ease of movement of the wrists/waists. The lobster claw hooks are located at each end of the coiled tether and are clipped to a D-ring on each Safety Bangle.
8. On each end, the coiled tether will then be threaded through the 1 inch, lobster claw hook and looped back into the ferrule and clamped tightly together by a vice to ensure the loop stays in tact.
9. The coiled tether will be threaded at each end through a 1 inch long ferrule (double barrel that is approximately ⅛ inch thick) at each end. The ferrule will be covered with a rubber foam tube to protect from rubbing against it.

FIG. C: Banglet Construction
10. Isometric View—The Banglets (charms) are also made of the same rubber-type material and are inserted into the holes.
11. Cross Section—The Banglet has a larger flat disk bottom with an approximately ½″ stem which can be pushed into an approximately ½″ hole of the Bangle and remain tight and secure.
12. The rubber of the Safety Bangle will flex to ensure the insert of the Banglet and also a tight fit to keep the Banglet from falling out. The holes on the Safety Bangle are made smaller than the end of the Banglet to ensure that the Banglet stays in place and does not come loose or fall out, but does allow an adult to change them out if needed. The base of the Banglet will be slightly concave to provide reverse pressure and keep the Banglet in place.

What I claim as my invention is:

1. Low cost, safety solution to an increasing crime rate of child abduction.

2. Flexible rubber/plastic coil tether which stays coiled for about 18 inches unless pulled on to stretch it out to approximately 36 inches.

3. Coil is to keep tether from hanging loosely and wrapping around objects; therefore promotes safety compared to other tethers that have slack. Coiled tether reduces slack which may cause tripping hazards for wearers and others.

4. Lack of slack in coiled tether keeps child or guided individual close in crowded environments.

5. Allows freedom for child or guided individual to walk on its own when the coiled tether is stretched out without having to hold a guardian's hand.

6. Keeps guardians hands free to support child or guided individual, if necessary.

7. Lobster claw hooks that rotate for easy movement of the arms of each person. These hooks are extremely durable.

8. Hooks may also be placed in alternative locations for effectiveness and efficiencies (e.g. belt loop).

9. Buckled Safety Bangle that can be sized to the individual wrist avoiding: a) tight nylon straps that can rub and cause abrasion; b) easily pulled apart Velcro connections; or c) elastic-type wrist bands that can easily slip off the hand.

10. It is somewhat difficult to tether a child or guided individual that does not want to be tethered; therefore, the Safety Bangle offers aesthetic entertainment value through the Banglets that encourage the child or guided individual to wear something fun and decorative.

11. The Safety Bangle keeps the child or guided individual from having to: walking with their arm upright for prolonged periods of time, wear a potentially hot tethered backpack, wear a safety hazard from tripping on a long tethered leash, or a chest restricting harness.

12. Easy to put on and take off.

13. Ability to remove the coil by unclipping the lobster claw hooks on each side, while not in use, and still keep the Safety Bangles on for instant connectivity.
